(19) United States
(12) Patent Application Publication
(10) Pub. No.: US 2004/0081509 A1
(43) Pub. Date: Apr. 29, 2004

(54) Structure and method of coupling shaft member and cylindrical member

(75) Inventors: Kohei Yamanaka, Kanagawa (JP); Tetsuya Okamura, Kanagawa (JP); Fumiyuki Yamaoka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignees: HITACHI UNISIA AUTIMOTIVE LTD.; UNISIA JKC STEERING SYSTEMS, CO., LTD.

(21) Appl. No.: 10/684,684

(22) Filed: Oct. 15, 2003

(30) Foreign Application Priority Data
Oct. 15, 2002 (JP) 2002-299783

(51) Int. Cl. F16D 1/00

(52) U.S. Cl. 403/28

(57) ABSTRACT

A coupling structure includes a shaft member having an outer periphery formed with an axial groove and a circumferential groove, each groove having a cross section having opposed faces substantially parallel to each other; a cylindrical member fitted to the outer periphery of the shaft member and formed out of a material greater in linear expansion coefficient than that of the shaft member; and a caulked portion provided to the cylindrical member at a position corresponding to the grooves of the shaft member. The caulked portion has a deformed inner surface in press contact with the opposed faces of the grooves.

### BACKGROUND OF THE INVENTION

The present invention relates to a structure and method of coupling a shaft member and a cylindrical member used, for example, for a torque sensor of an electric power steering apparatus.

A typical structure of coupling a shaft member and a cylindrical member is disclosed in U.S. Pat. No. 6,301,975. This coupling structure is applied to a torque sensor of an electric power steering apparatus to couple an output shaft and a cylindrical member fixed thereto by caulking. The torque sensor has axial grooves and a circumferential groove formed in the outer peripheral surface of a large-diameter portion arranged at an end of the output shaft. The axial grooves extend between both ends of the large-diameter portion, whereas the circumferential groove roughly corresponds to a position of an end of the cylindrical member when fixing the cylindrical member.

Semispherical protrusions are formed on the inner peripheral surface of the cylindrical member at the position slightly inward of the lower end. The protrusions are arranged such that the number and formed position correspond to those of the axial grooves of the output shaft, and the height is substantially equal to the depth of the axial grooves.

When fixing the cylindrical member to the large-diameter portion of the output shaft, the protrusions of the cylindrical member are engaged in the axial grooves of the output shaft to push the cylindrical member to the output shaft. Then, the front end of the protrusions is urged to move in coming in press contact with the bottom of the axial grooves. This allows circumferential positioning of the cylindrical member with respect to the output shaft. Then, the cylindrical member is pushed to the output shaft to have an end close to the circumferential groove. In this state, the end of the cylindrical member is caulked inwardly to engage in the circumferential groove, thus fixing the cylindrical member to the large-diameter portion of the output shaft.

With the above torque sensor, however, when fixing the cylindrical member to the output shaft, the protrusions of the cylindrical member are engaged in the axial grooves of the output shaft to push directly strongly the cylindrical member to the output shaft. Thus, the cylindrical member may be deformed upon pushing.

Specifically, as being mainly formed of a thin aluminum-alloy material as conductive non-magnetic material, the cylindrical member is low in rigidity and thus strength. And when press fitting the cylindrical member to the output shaft, the cylindrical member is held by a holding device, for example, which provides to the outer periphery of the cylindrical member a load in the diameter reducing direction. Thus, the cylindrical member can produce plastic deformation, leading to occurrence of distortion. This changes a shape of a magnetic path, resulting in a reduction in torque detection accuracy obtained by the torque sensor.

### SUMMARY OF THE INVENTION

It is, therefore, an object of the present invention to provide a structure and method of coupling a shaft member and a cylindrical member, which causes no plastic deformation of the cylindrical member and allows strong coupling between the shaft member and the cylindrical member when having a change in atmospheric temperature.

The present invention provides generally a structure which comprises: a shaft member, the shaft member being formed out of a first material, the shaft member having an outer periphery formed with at least one of an axial groove and a circumferential groove, the at least one groove having a cross section having opposed faces substantially parallel to each other; a cylindrical member fitted to the outer periphery of the shaft member, the cylindrical member being formed out of a second material, the second material being greater in linear expansion coefficient than the first material; and a caulked portion provided to the cylindrical member at a position corresponding to the at least one groove of the shaft member, the caulked portion having a deformed inner surface in press contact with the opposed faces of the at least one groove.

### BRIEF DESCRIPTION OF THE DRAWINGS

FIG. 1 is a schematic view showing an electric power steering apparatus to which the present invention is applied;

FIG. 2 is a longitudinal sectional view showing the electric power steering apparatus;

FIG. 3 is an exploded perspective view showing the electric power steering apparatus;

FIG. 4 is a perspective view showing a member to be surrounded;

FIG. 5 is an enlarged fragmentary sectional view showing the electric power steering apparatus;

FIG. 6 is a fragmentary plan view showing a spacer;

FIG. 7 is a sectional view taken along the line VII-VII in FIG. 6;

FIG. 8 is a front view showing an input shaft of the electric power steering apparatus;

FIG. 9 is a view similar to FIG. 2, showing a torque-detection-side surrounding member fixed to the input shaft by caulking;

FIG. 10 is a view similar to FIG. 7, taken along the line X-X in FIG. 9;

FIG. 11 is an enlarged view showing a portion C in FIG. 10;

FIG. 12 is a view similar to FIG. 10, taken along the line XII-XII in FIG. 11;

FIG. 13 is a view similar to FIG. 12, taken along the line XIII-XIII in FIG. 11;

FIG. 14 is a diagrammatic view showing an inner-periphery-side cylinder caulked by a caulker;

FIG. 15A is a side view showing the caulker;

FIG. 15B is a view similar to FIG. 8, showing the caulker;

FIG. 16 is a plan view showing the torque-detection-side surrounding member and a temperature-compensation-side surrounding member;

FIG. 17 is a view similar to FIG. 13, taken along the line XVII-XVII in FIG. 16;

FIG. 18 is a view similar to FIG. 4, showing the torque-detection-side and temperature-compensation-side surrounding members;

FIG. 19 is a graph illustrating a temperature-stress characteristic of a caulked part; and

FIGS. 20A-20D are schematic sectional views showing stress distribution in the caulked part when having a change in atmospheric temperature or in accordance with very cold temperature, low temperature, high temperature, and very hot temperature.

### DETAILED DESCRIPTION OF THE INVENTION

Referring to the drawings, a description is made about an embodiment of a structure and method of coupling a shaft member and a cylindrical member according to the present invention. In the embodiment, the present invention is applied to a torque sensor for an electric power steering apparatus.

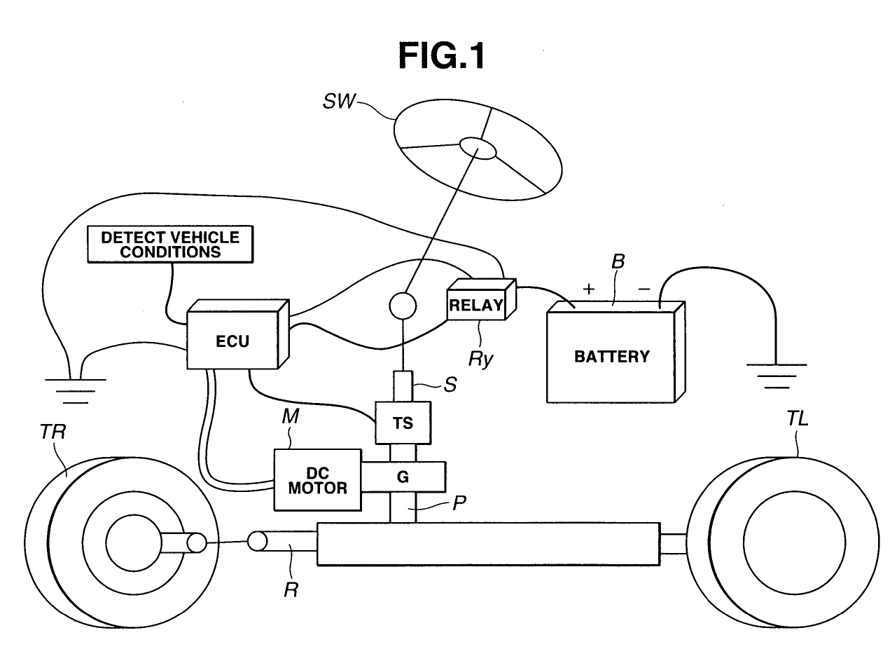

Referring to FIG. 1, the electric power steering apparatus comprises a torque sensor TS and a steering wheel SW. When rotating steering wheel SW with hands, rotation of a rotation shaft S is converted into linear motion of a rack R through rack R and pinion P, allowing a change in orientation or steering of right and left front wheels TR, TL. Moreover, pinion P is constructed to be rotatable by a DC electric motor M through a reduction gear G, providing assistance to a steering force produced manually as described above.

Electric motor M is controlled by a microcomputer of a vehicle-mounted electronic control unit ECU in accordance with a signal out of torque sensor TS for sensing a manual steering force, thus carrying out assistance control of a manual steering force. The electric power steering apparatus also comprises a fail-safe relay Ry and a vehicle-mounted battery B.

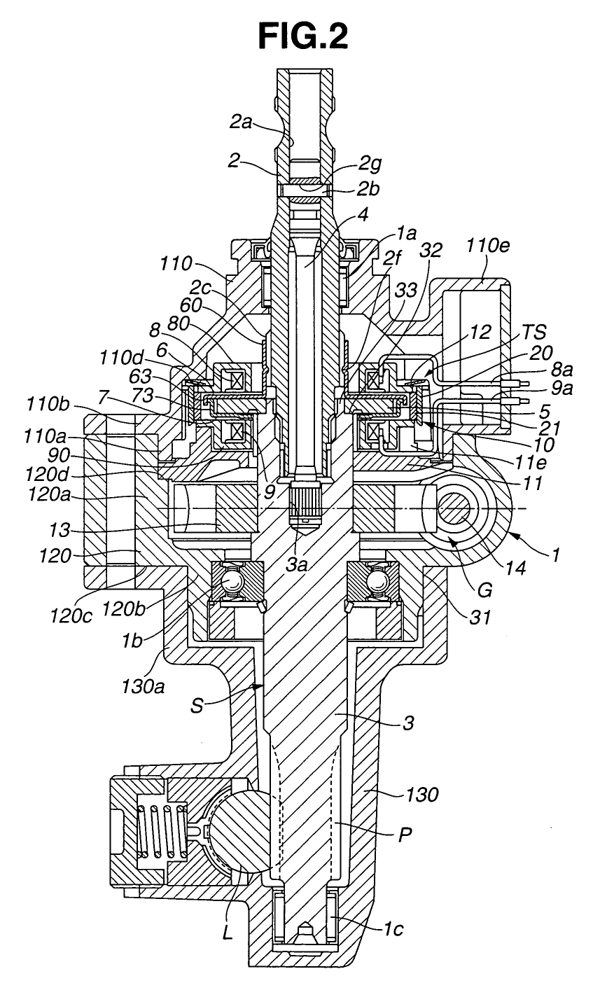

Referring to FIGS. 2-10, torque sensor TS comprises a housing 1, an input shaft or shaft member 2, an output shaft 3, a torsion bar or elastic body 4, a member to be surrounded 5, a torque-detection-side surrounding member or cylindrical member 6 which serves as a magnetic-path blocking part, a temperature-compensation-side surrounding member 7 which serves as a magnetic-path blocking part, a torque detection coil or first detection coil 8, a temperature compensation coil or second detection coil 9, a spacer 10, a base member 11, a disc spring 12, an output-shaft-side worm wheel 13, and a motor-shaft-side worm shaft 14.

Housing 1 comprises three divided portions, i.e. an upper housing 110 for mainly accommodating torque sensor TS, a central housing 120 for mainly accommodating reduction gear G, and a lower housing 130 for mainly accommodating rack R and pinion P. The three 110, 120, 130 are assembled axially to form the unity of housing 1.

Specifically, a lower-end opening edge 110a of upper housing 110 is inserted into a large-diameter portion 120a of central housing 120 arranged at the upper part thereof, and a flange 119b of upper housing 110 is engaged on an opening upper-end face of central housing 120. Then, upper housing 110 and central housing 120 are fixed through a bolt and the like.

Moreover, a small-diameter portion 120b of central housing 120 arranged at the lower part thereof is mounted in a large-diameter portion 130a of lower housing 130 arranged at the upper end of lower housing 130, and the upper end face of large-diameter portion 130a is engaged on an annular stepped face 120c of central housing 120. Then, central housing 120 and lower housing 130 are fixed through a bolt and the like.

Input shaft 2 and output shaft 3 are coaxially disposed in housings 110, 120, 130, and are rotatably supported through bearings 1a, 1b, 1c.

Torsion bar 4 is rotatably arranged through a center hole 2a of input shaft 2, and has one end fixed to input shaft 2 in the interior of center hole 2a through a pin 2b and another end press fitted into a center hole 3a of output shaft 3.

Steering wheel SW is coupled to input shaft 2, a steering force of which is provided through input shaft 2, torsion bar 4, and output shaft 3 to rack R and pinion P arranged at the lower end of output shaft 3, wherein it is converted into linear motion and transmitted to right and left front wheels TR, TL.

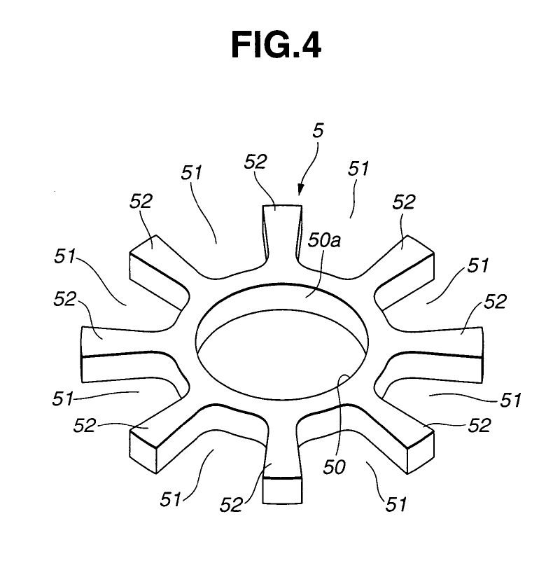

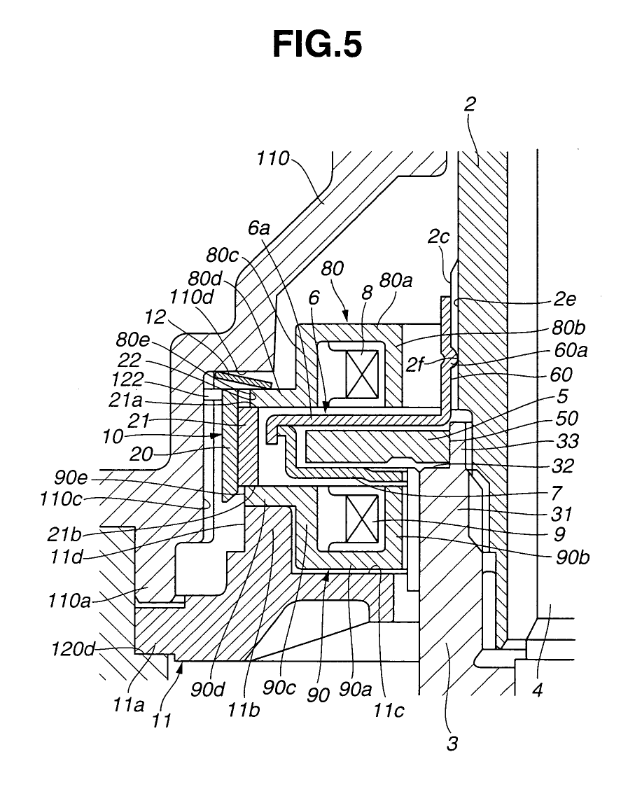

Surrounded member 5 serves to form a path of magnetic field generated by torque detection coil 8 and temperature compensation coil 9, and is formed out of a magnetic material such as stainless steel by sintering. Referring to FIG. 5, member 5 is press-fit coupled to the outer periphery of a small-diameter portion 33 arranged in upper housing 110 and at the upper end, i.e. input-shaft 2 side end, of output shaft 3 and having an annular stepped face 32 with respect to a main body 31. Referring to FIG. 4, member 5 has, at the outer periphery of an annular base having in the center a coupling hole 50 for press-fit coupling to small-diameter portion 33, a plurality of (eight in the embodiment) recessed parts 51 formed axially and at predetermined circumferential intervals and non-recessed parts or magnetic-path forming parts 52. A serration 50a is integrally formed on the inner peripheral surface of coupling hole 50 during sintering of member 5.

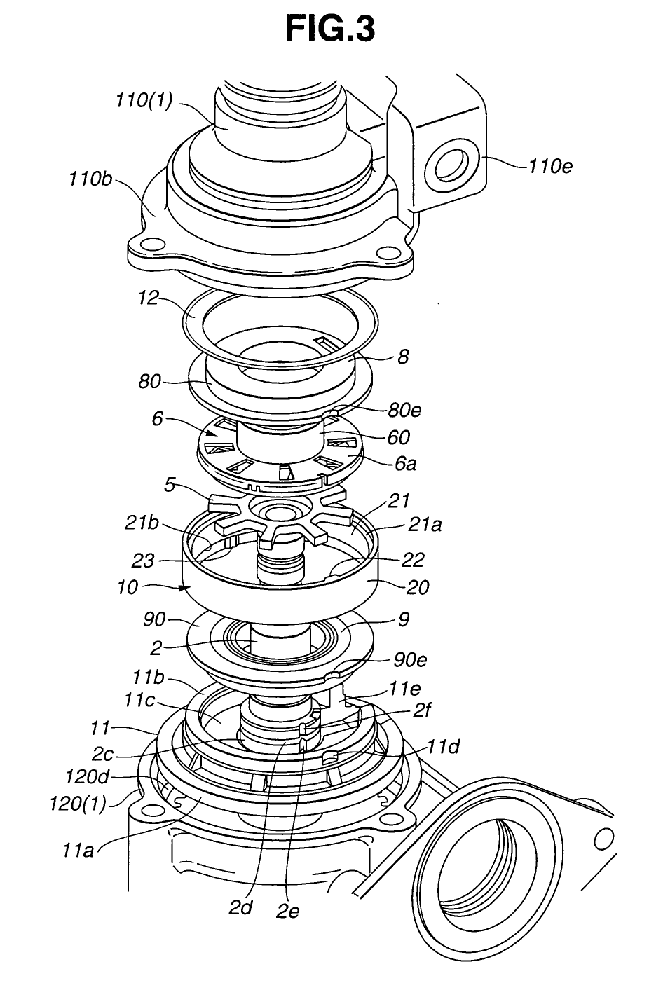

Torque detection coil 8 serves to detect torque acting between input shaft 2 and output shaft 3 in accordance with an impedance change. Referring to FIGS. 2 and 3, facing axially an input-shaft-side face of surrounded member 5, torque detection coil 8 is fixed to upper housing 110 through a yoke member 80 for surrounding coil 8 except its lower face, generating the magnetic field having member 5 and yoke member 80 as magnetic path.

Referring to FIG. 5, yoke member 80 comprises an upper-face surrounding part 80a constituting a main body of gate-shaped section for surrounding torque detection coil 8 except its lower face opposite to surrounded member 5, an inner-periphery surrounding part 80b, an outer-periphery surrounding part 80c, and a stationary flange part 80d protruding outwardly from a lower-end opening edge of outer-periphery surrounding part 80c. Outer-periphery surrounding part 80c from which stationary flange part 80d protrudes outwardly is greater in thickness than upper-face surrounding part 80a and inner-periphery surrounding part 80b so as to prevent leakage of magnetic flux toward stationary flange part 80d.

Temperature compensation coil 9 serves to correct a variation in value of torque detected by torque detection coil 8 due to temperature change. Facing axially an output-shaft-side face of surrounded member 5, temperature compensation coil 9 is fixed to upper housing 110 through a yoke member 90 for surrounding coil 9 except its upper face, generating the magnetic field having member 5 and yoke member 90 as magnetic path.

Referring to FIG. 5, yoke member 90 comprises a lower-face surrounding part 90a constituting a main body of gate-shaped section for surrounding temperature compensation coil 9 except its upper face opposite to surrounded member 5, an inner-periphery surrounding part 90b, an outer-periphery surrounding part 90c, and a stationary flange part 90d protruding outwardly from an upper-end opening edge of outer-periphery surrounding part 90c. Outer-periphery surrounding part 90c from which stationary flange part 90d protrudes outwardly is greater in thickness than upper-face surrounding part 90a and inner-periphery surrounding part 90b so as to prevent leakage of magnetic flux toward stationary flange part 90d.

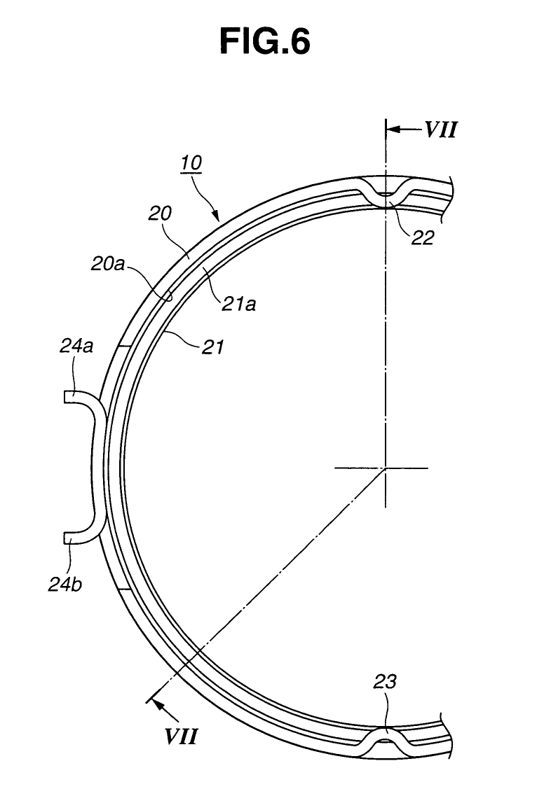

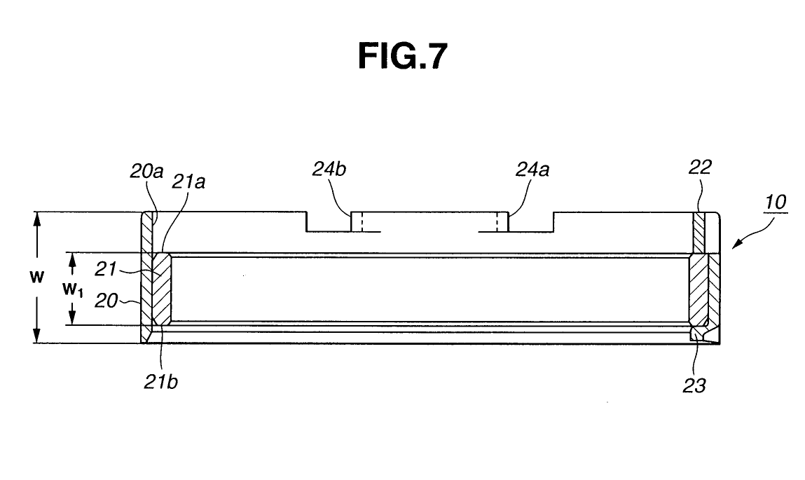

Spacer 10 is interposed between yoke member 80 of torque detection coil 8 and yoke member 90 of temperature compensation coil 9 to determine an axial clearance therebetween. Spacer 10 comprises inner and outer rings 20, 21. Specifically, referring to FIGS. 6 and 7, spacer 10 is formed out of an aluminum-alloy material as non-magnetic metallic material, and comprises double cylinders having cylindrical outer ring 20 and cylindrical inner ring 21 press fitted therein along the inner peripheral surface. Outer ring 20 has a thickness smaller than that of inner ring 21, and a width W greater than a width W1 of inner ring 21. On the other hand, inner ring 21 is shaped like a simple cylinder, and is press fitted into outer ring 20 in the vicinity of the lower end of an inner peripheral surface 20a. Inner ring 21 has an upper end formed with an annular stepped face 21a to axially position and engage stationary flange part 80d of yoke member 80, and a lower end formed with an annular stepped face 21b to axially position and engage stationary flange part 90d of yoke member 90. Thus, the axial length of inner ring 21 between annular stepped faces 21a, 21b defines an axial positional relationship between torque detection coil 8 and temperature compensation coil 9.

As best seen in FIG. 7, axial protrusions or engagements 22, 23 are formed at the upper and lower ends of inner peripheral surface 20a of outer ring 20 by inward press caulking to circumferentially position and engage yoke members 80, 90. Referring to FIG. 3, recesses 80e, 90e are formed through the outer peripheral surface of stationary flange parts 80d, 90d, with which axial protrusions 22, 23 are engaged. Referring also to FIG. 2, recesses 80e, 90e are arranged to circumferentially correspond to each other with coil harnesses 8a, 9a circumferentially aligned with each other with respect to the direction of protrusion.

As best seen in FIG. 2, base member 11 is mounted with a lower flange part 11a engaged on an engagement step 120d formed inside large-diameter portion 120a of central housing 120. An annular concave 11c is formed inside an upper small-diameter cylindrical part 11b of base member 11 to accommodate the main body of yoke member 90. Upper small-diameter cylindrical part 11b is inserted through a lower-end opening of spacer 10 to have an upper end face on which stationary flange part 90d of yoke member 90 abuts. Thus, the axial length of base member 11 defines an axial positional relationship between central housing 120 (housing 1) and torque detection coil 8 and temperature compensation coil 9.

As best seen in FIG. 3, a recess 11d is formed in the outer peripheral surface of upper small-diameter cylindrical part 11b, in which axial protrusion 23 of spacer 10 is engaged. With axial protrusion 23 engaged in recess 11d, coil harness 9a is circumferentially aligned with a harness leading groove 11e formed in base member 11.

As shown in FIGS. 6 and 7, pairs of positioning protrusions 24a, 24b are integrally formed at the upper end of outer ring 20 of spacer 10 in the 180° circumferentially angularly distant positions. Positioning protrusions 24a, 24b are obtained by outwardly bending part of the upper end of outer ring 20 by a press to provide a roughly C-shaped section as viewed in plan. On the other hand, an axial engagement groove 122 is formed in the inner peripheral surface of upper housing 110 radially opposite to positioning protrusions 24a, 24b, in which positioning protrusions 24a, 24b are engaged. With positioning protrusions 24a, 24b engaged in axial engagement groove 122, coil harnesses 8a, 9a are circumferentially aligned with a wiring box 110e formed at one side of upper housing 110. That is, positioning protrusions 24a, 24b and axial engagement groove 122 prevent relative rotation between upper housing 110 and spacer 10.

With disc spring 12 interposed between stationary flange part 80d and an annular step 110d formed inside upper housing in the axially middle position, upper housing 110 is assembled and fixed to central housing 120 by a bolt and the like. While preventing positional displacement by a biasing force of disc spring 12 and maintaining an axial positional relationship, yoke members 80, 90 (torque detection coil 8 and temperature compensation coil 9) are assembled to housing 1.

Torque-detection-side surrounding member 6 is integrally formed out of an aluminum-alloy material as conductive non-magnetic metallic material. Surrounding member 6 is fixed to input shaft 2 by caulking an inner-periphery-side cylinder 60 as will be described later on the outer periphery of input shaft 2 formed out of a ferrous metallic material of lower linear expansion coefficient than that of surrounding member 6.

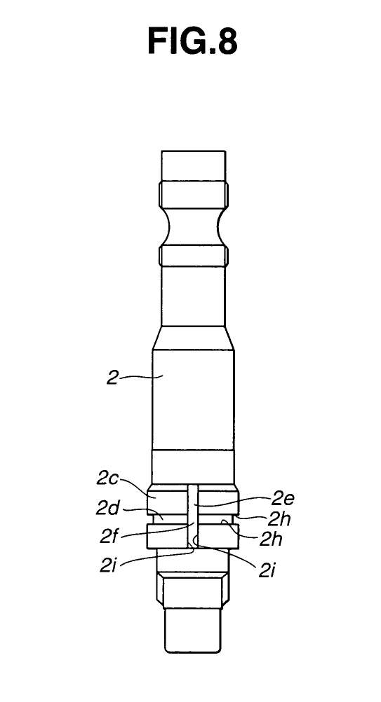

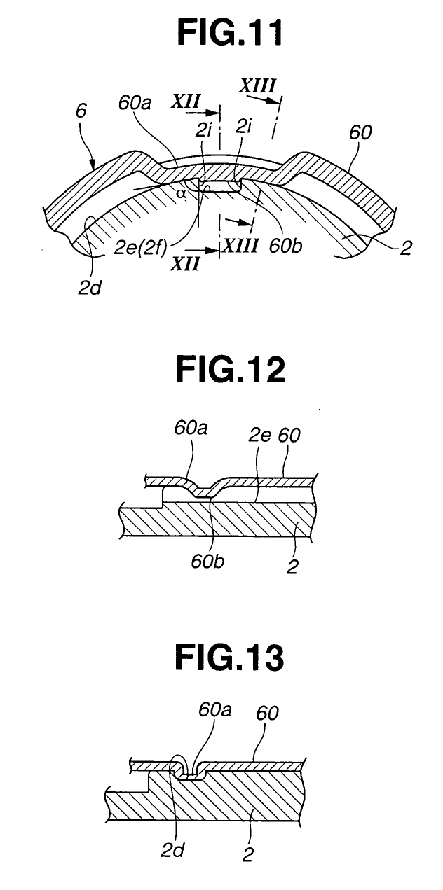

Specifically, referring to FIGS. 8 and 10, input shaft 2 has a circumferential groove 2d of roughly rectangular cross section formed in the outer peripheral surface of a maximum outer-diameter portion 2c arranged close to the lower end, and three axial grooves 2e of roughly rectangular cross section formed axially in maximum outer-diameter portion 2c. Circumferential groove 2d is formed roughly in the longitudinal center of maximum outer-diameter portion 2c, whereas axial grooves 2e are formed in the 120° circumferentially angularly distant positions of maximum outer-diameter portion 2c. Referring to FIGS. 10 and 11, axial groove 2e is greater in depth than circumferential groove 2d. A concave 2f is formed at the position of intersection of two grooves 2d, 2e, an opening edge of which forms an acute angle of a <90° by forming axial groove 2e of rectangular section in input shaft 2 of circular section, thus allowing stronger fixing of inner-periphery-side cylinder 60 of torque-detection-side surrounding member 6 as will be described later. Circumferential groove 2d and axial groove 2e are of a roughly rectangular cross section to provide opposed faces 2h, 2h; 2i, 2i parallel to each other along the length direction.

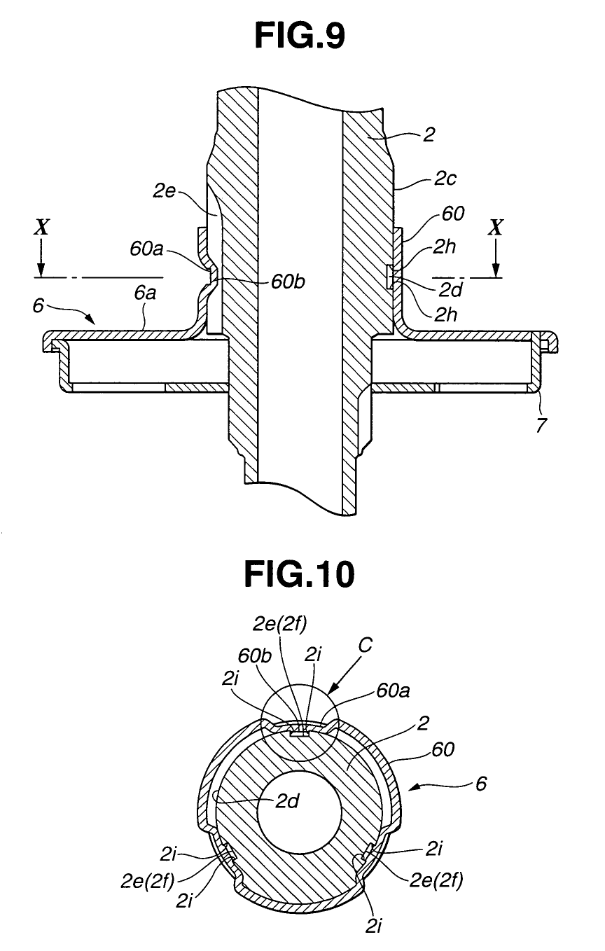

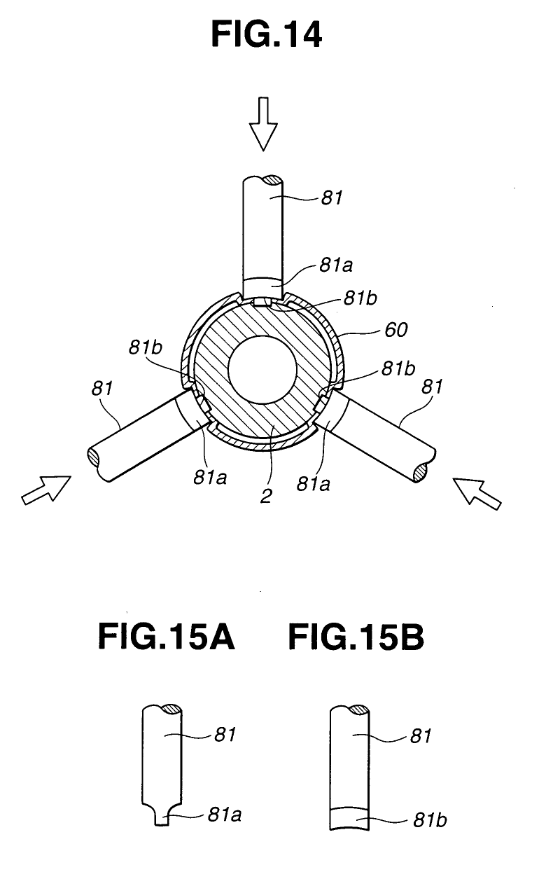

Referring to FIG. 9, torque-detection-side surrounding member 6 comprises a roughly disc-shaped main body 6a and an inner-periphery-side cylinder 60 integrated with main body 6a in the center thereof. Inner-periphery-side cylinder 60 is fitted to the outer peripheral surface of maximum outer-diameter portion 2c of input shaft 2. Referring to FIGS. 10-15B, inner-periphery-side cylinder 60 has a circumferential or first caulked part 60a and an axial or second caulked part 60b engaged tightly in part of circumferential groove 2d and concave 2f by driving a caulker 81 such as a punch to inner-periphery-side cylinder 60 at the position corresponding to the position of intersection of two grooves 2d, 2e, i.e. concave 2f and part of circumferential groove 2d. With this, torque-detection-side surrounding member 6 is circumferentially axially positioned with respect to input shaft 2 for fixing thereto. Referring to FIGS. 15A and 15B, caulker 81 has a tip 81a formed roughly flat so as to conform to circumferential groove 2d, and a tip 81b formed circularly along the circular shape of circumferential groove 2d. Inner-periphery-side cylinder 60 has three caulked spots which are about 120° circumferentially angularly distant from each other.

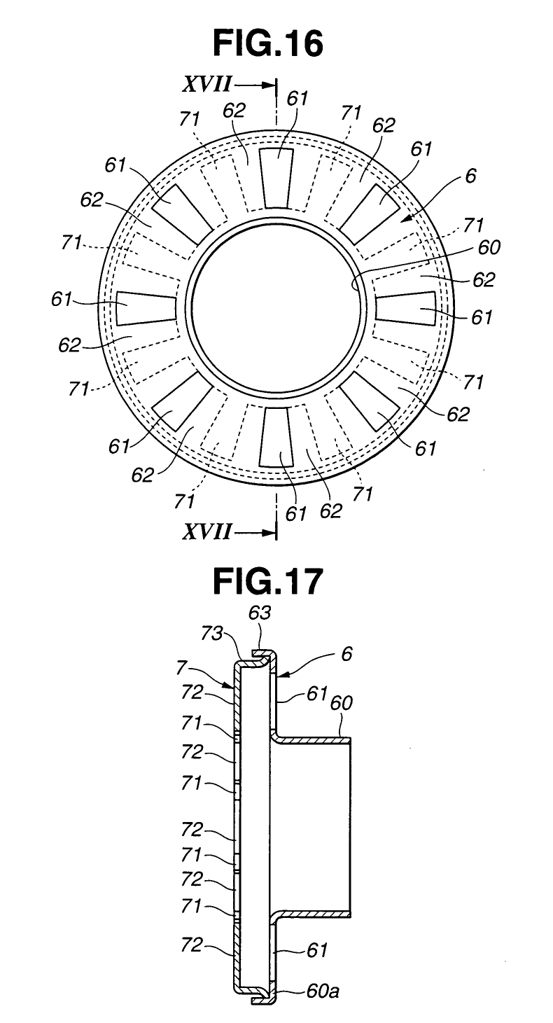

By fixing inner-periphery-side cylinder 60 to input shaft 2 as described above, torque-detection-side surrounding member 6 is interposed between surrounded member 5 and torque detection coil 8 with a predetermined clearance. Referring to FIGS. 16-18, a plurality of (eight in the embodiment) windows or recesses 61 having the number corresponding to that of recessed parts 51 and non-recessed parts 52 of surrounded member 5 are axially formed through surrounding member 6 at predetermined circumferential intervals. The circumferential width of window 61 is equal to the width of non-recessed part 52 of surrounded member 5.

Torque produced between input shaft 2 and output shaft 3 is detected by detecting a change in superimposition of windows 61 of torque-detection-side surrounding member 6 and non-recessed parts 52 of surrounded member 5 in accordance with an impedance change.

Temperature-compensation-side surrounding member 7 is interposed between surrounded member 5 and temperature compensation coil 9. As shown in FIG. 17, surrounding member 7 has an inner periphery unrestricted or not fixed to output shaft 3, and an outer periphery formed with an outer cylinder or connection 73 which extends axially for integral coupling to an outer cylinder or connection 63 of torque-detection-side surrounding member 6 which also extends axially. This allows unitary rotation of two surrounding members 6, 7.

As shown in FIG. 16, window 61 of torque-detection-side surrounding member 6 and a window 71 of temperature-compensation-side surrounding member 7 are disposed with a 222° angle of rotation offset with each other. With no torque being applied to input shaft 2, i.e. a torque value being zero, the widths of non-recessed part 62, 72 between windows 61 of torque-detection-side surrounding member 6 and between windows 71 of temperature-compensation-side surrounding member 7 are equal to the circumferential width of non-recessed part 52 of surrounded member 5. Non-recessed part 52 of surrounded member 5 is axially superimposed on that width portion.

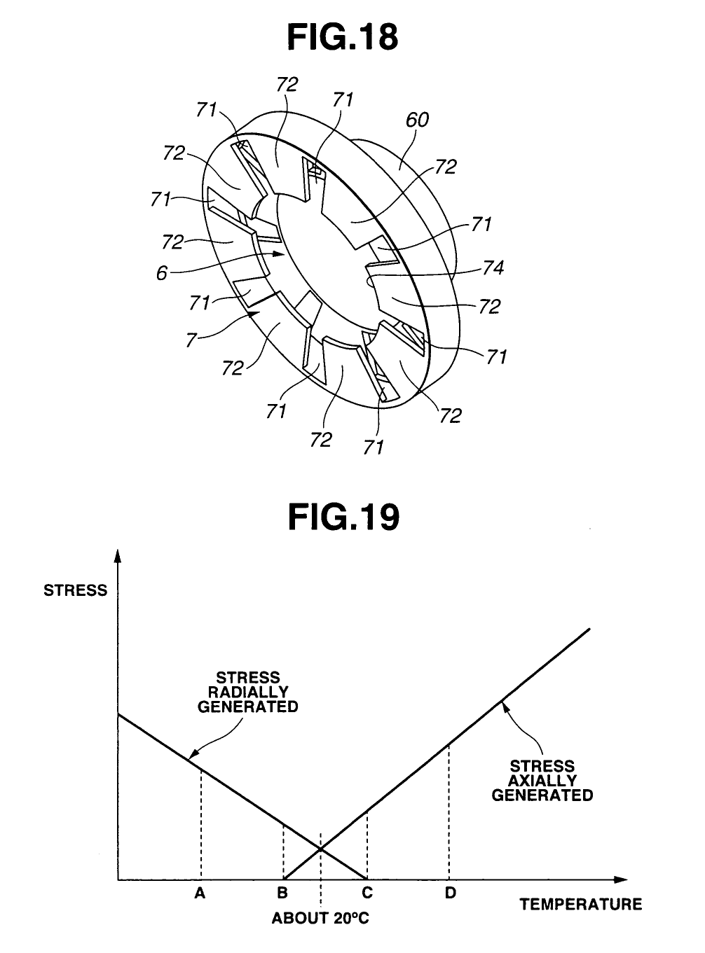

Referring to FIG. 18, window 71 of temperature-compensation-side surrounding member 7 has a center-side portion formed like a recess communicating with a center hole or through hole 74, which allows the annular base and non-recessed part 52 of surrounded member 5 to axially pass through surrounding member 7.

Maximum outer-diameter portion 2c of input shaft 2 is smaller than the inner diameters of inner-periphery-side cylinder 60 of torque-detection-side surrounding member 6, coupling hole 50 of surrounded member 5, and yoke members 80, 90 for accommodating torque detection coil 8 and temperature compensation coil 9. This allows assembling of those sensor members from the side of input shaft 2.

Next, a procedure of assembling the members is described.

(A) Output shaft 3 having a bearing 1b press fitted therein is inserted into central housing 120 from below to press fit bearing 1b to the inner surface of small-diameter portion 120b, assembling the middle portion of output shaft 3 to central housing 120 so as to rotatably be supported thereby. With torsion bar 4 having a lower end spline engaged in center hole 3a of output shaft 3 and an upper end inserted into center hole 2a of input shaft 2, a pin mounting hole 2g is formed to extend through torsion bar 4 and input shaft 2 in the diameter direction. A pin 2c is press fitted into mounting hole 2g to fix the upper end of torsion bar 4 to input shaft 2. After removing cutting oil and chips produced during formation of pin mounting hole 2g, assembling proceeds to a next process.

(B) Small-diameter portion 120b of central housing 120 is inserted into large-diameter portion 130a of lower housing 130, and pinion P is engaged with rack R by rotating output shaft 3. Finally, the lower end of output shaft 3 is press fitted into bearing 1c press fitted into lower housing 130, assembling the lower end of output shaft 3 to lower housing 130 so as to rotatably be supported thereby.

(C) Worm wheel 13 is press fitted to output shaft 3 in central housing 120.

(D) Base member 11 is assembled with lower flange part 11a engaged on annular step 120d formed in large-diameter portion 120a of central housing 120.

(E) Yoke member 90 (temperature compensation coil 9) is assembled with the main body of yoke member 90 accommodated in annular concave 11c of base member 11, and stationary flange part 90d engaged on the upper end face of upper small-diameter cylindrical part 11b of base member 11.

(F) Surrounded member 5 is assembled to smaller-diameter portion 33 of output shaft 3 by press fitting coupling hole 50 thereto. At that time, a clearance between temperature compensation coil 9 and surrounded member 5 is measured by using a sensor and the like to carry out axial positioning of surrounded member 5.

(G) Torque-detection-side surrounding member 6 having temperature-detection-side surrounding member 7 integrated therewith is fixed to maximum outer-diameter portion 2c of input shaft 2 through inner-periphery-side cylinder 60 by caulking as described above. At that time, since a slight clearance exists between inner-periphery-side cylinder 60 and maximum outer-diameter portion 2c of input shaft 2, surrounding member 6 is loosely fitted to the outer periphery of maximum outer-diameter portion 2c.

At that time, as described above, the annular base and non-recessed part 52 of surrounded member 5 can axially pass through temperature-detection-side surrounding member 7. Thus, surrounding member 7 is axially disposed to form a predetermined clearance between surrounded member 5 and temperature compensation coil 9. And surrounding member 7 is circumferentially disposed so that the difference is zero between impedance detected by torque detection coil 8 and that detected by temperature compensation coil 9, i.e. the magnetic field is completely blocked by non-recessed parts 62, 72 of torque-detection-side and temperature-compensation-side surrounding members 6, 7.

In this state, part of inner-periphery-side cylinder 60 is driven into concave 2f by caulker 81 as shown in FIGS. 9-14 so as to tightly engage circumferential and axial caulked parts 60a, 60b in circumferential groove 2d and concave 2f. Specifically, circumferential caulked part 60a produces plastic deformation to tightly engage with opposed faces 2h, 2h of circumferential groove 2d, whereas axial caulked part 60b produces plastic deformation to tightly engage with four opposed faces of concave 2f. This allows axial and circumferential positioning and firm fixing of torque-detection-side and temperature-detection-side surrounding members 6, 7 with respect to input shaft 2.

(H) Spacer 10 is assembled with downward annular stepped face 21b engaged on the upper face of stationary flange part 90d of yoke member 90 of temperature compensation coil 9. At that time, axial protrusion 23 of spacer 10 is engaged in recess 90e of stationary flange part 90d and recess 11d of base member 11 to circumferentally position spacer 10. This allows circumferential alignment of coil harness 9a of temperature compensation coil 9 and harness leading groove 11e of base member 11.

(I) Yoke member 80 (torque detection coil 8) is assembled with stationary flange part 80d engaged on upward annular stepped face 21a of spacer 10. At that time, axial protrusion 22 of spacer 10 is engaged in recess 80e of stationary flange part 80d to circumferentially position yoke member 80. This allows arrangement of torque-detection-side surrounding member 6 between surrounded member 5 and torque detection coil 8 with a predetermined clearance due to a preset interval between annular stepped faces 21a, 21b, and circumferential alignment of coil harnesses 8a, 9a of torque detection coil 8 and temperature compensation coil 9 with respect to the direction of protrusion.

(J) Upper housing 110 is assembled to central housing 120 with disc spring 12 disposed on stationary flange part 80d of yoke member 80. Specifically, input shaft 2 is press fitted into bearing 1a press fitted in the center hole of upper housing 110 to rotatably be supported to upper housing 110. Lower-end opening edge 110a of upper housing 110 is inserted into large-diameter portion 120a arranged in the upper part of central housing 120, and flange 110b of upper housing 110 is engaged on the upper end face of the opening of central housing 120. In this state, upper and central housings 110, 120 are axially fixed by a bolt and the like to have disc spring 12 compressed between stationary flange part 80d and annular step 110d, which provides a strong reaction force to axially hold and fix yoke member 80, spacer 10, yoke member 90, and base member 11 between disc spring 12 and annular step 110d. Upon assembling of upper housing 110, positioning protrusions 24a, 24b formed on the outer periphery of spacer 10 are engaged in axial engagement groove 122 in the inner peripheral surface of upper housing 110. This allows circumferential alignment of coil harnesses 8a, 9a and wiring box 110e formed at one side of upper housing 110.

Next, an operation and effect of torque sensor TS is described.

In the embodiment, torque sensor TS is constructed as described above, so that when torque is zero, the magnetic field is completely blocked by non-recessed parts 62, 72 of torque-detection-side and temperature-compensation-side surrounding members 6, 7. As a result, the difference is roughly zero between an impedance value detected by torque detection coil 8 and that detected by temperature compensation coil 9, i.e. a torque value is zero.

When torque increases from zero torque value to act on input shaft 2, torsion bar 4 is twisted in accordance with a torque amount when torque of input shaft 2 is transmitted to output shaft 3 through torsion bar 4, causing relative rotation of surrounded member 5 and torque-detection-side surrounding member 6. With this, non-recessed parts 52 of surrounded member 5 produce relative rotation in the direction to coincide with window 61 of torque-detection-side surrounding member 6, so that an impedance value detected by torque detection coil 8 varies with a relative rotation amount. On the other hand, non-recessed parts 52 of surrounded member produce relative rotation in the direction to coincide with non-recessed part 72 of temperature-compensation-side surrounding member 7, so that an impedance valued detected by temperature compensation coil 9 varies with a relative rotation amount. That is, two impedance values vary in the reverse direction, i.e. in the plus and minus directions with respect to roughly zero impedance difference.

Then, detection of a differential value between a plus-direction impedance value detected by torque detection coil 8 and a minus-direction impedance value detected by temperature compensation coil 9 can provide a torque value as always temperature compensated. Moreover, it can provide a greater value as a differential value between two impedance values, resulting in enhancement in torque detection accuracy.

Further, in the embodiment, maximum outer-diameter portion 2c of input shaft 2 is smaller than the inner diameters of inner-periphery-side cylinder 60 of torque-detection-side surrounding member 6, coupling hole 50 of surrounded member 5 fixed to output shaft 3, and yoke members 80, 90 for accommodating torque detection coil 8 and temperature compensation coil 9. Thus, even after connecting input shaft 2 and output shaft 3 through torsion bar 4, not only surrounding members 6, 7 fixed to input shaft 2, but also surrounded member 5 fixed to output shaft 3 and torque detection coil 8 and temperature compensation coil 9 fixed to housing 1 can be all mounted from the side of input shaft 2. This results in an enhancement in assembling workability.

Moreover, since surrounding members 6, 7 are fixed to input shaft 2, torque detection coil 8 on the side of input shaft 2 can be inserted after fixing surrounding members 6, 7, leading to easy fixing of surrounding members 6, 7 to input shaft 2.

Further, temperature-compensation-side surrounding member 7 has a center portion formed with center hole 74 which allows input shaft 2 and the annular base of surrounded member 5 to pass therethrough, and a portion opposite to non-recessed parts 52 of surrounded member 5, in which windows 71 are radially formed to communicate with center hole 74 and allow non-recessed parts 52 to pass therethrough. With this, surrounded member 5 can axially be arranged through temperature-compensation-side surrounding member 7. Thus, after fixing surrounded member 5 to output shaft 3, a surrounding-member assembly having torque-detection-side and temperature-compensation-side surrounding members 6, 7 integrated together through outer cylinders 63, 73 can be inserted from the side of input shaft 2 to assemble surrounding members 6, 7 in such a way as to hold surrounded member 5 from two axial faces. This results in a further enhancement in assembling workability.

Still further, torque-detection-side surrounding member 6 is fixed to input shaft 2 by caulking inner-periphery-side cylinder 60 in circumferential groove 2d and concave 2f previously formed in the outer peripheral surface of maximum outer-diameter portion 2c of input shaft 2. This allows fine adjustment of sensor output by adjusting the positional relationship between surrounded member 5 and torque detection coil 8 and temperature compensation coil 9. Caulking is carried out after fine adjustment of sensor output, allowing prevention of relative rotation and axial movement from occurring between input shaft 2 and surrounding members 6, 7.

Furthermore, before caulking surrounding member 6 to input shaft 2, operation to be carried out is to loosely fit inner-periphery-side cylinder 60 to the outer periphery of input shaft 2, and no press-fit operation is required, obtaining sure prevention of plastic deformation and the like of inner-periphery-side cylinder 60, resulting in restraint of a reduction in detection accuracy obtained by torque sensor TS.

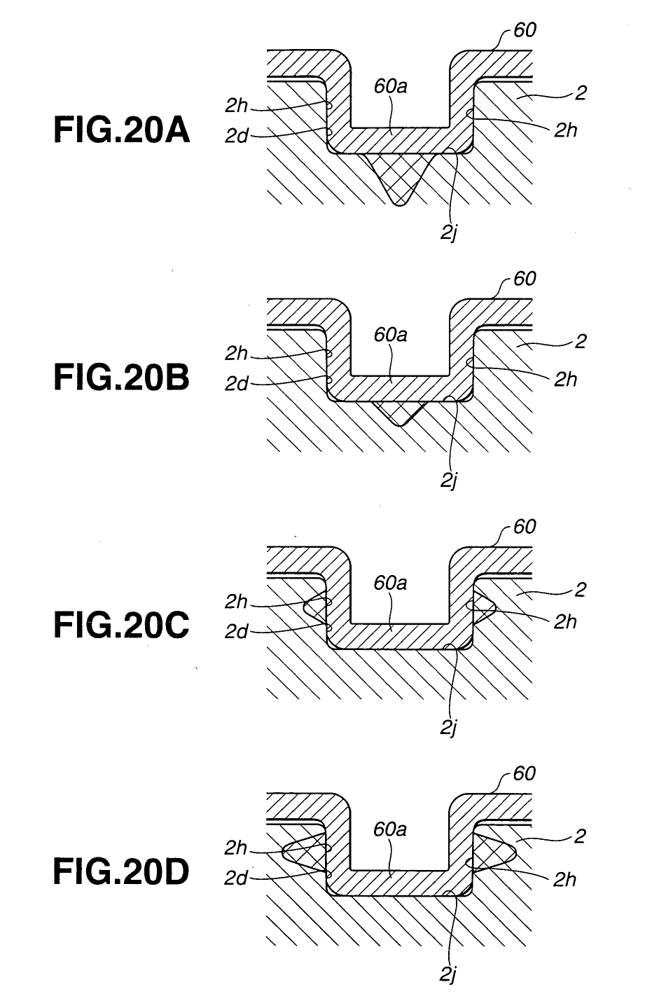

Referring to FIGS. 19-20D, when the atmospheric or outside-air temperature of torque sensor TS varies, a stress is generated at circumferential caulked part 60a to provide a sufficient coupling force between caulked part 60a and circumferential groove 2d and concave 2f. Specifically, caulking is carried out at an ordinary temperature of about 20° C. In this state, the protruding inner surface of circumferential caulked part 60a caused by plastic deformation is in press contact with opposed faces 2h, 2h, obtaining strong coupling by great frictional resistance or interference.

When the atmospheric temperature of torque sensor TS is, for example, very cold temperature of −40° C. or low temperature of 0° C., inner-peripheral-side cylinder 60 is greater in contraction-deformation amount than input shaft 2, thus obtaining the whole inner peripheral surface of cylinder 60 in press contact with the outer peripheral surface of input shaft 2. Particularly, circumferential caulked part 60a has slightly reduced friction resistance with opposed faces 2h, 2h by contraction deformation of inner-periphery-side cylinder 60. However, radial stresses generated at a point A (about −40° C.) and a point B (about 0° C.) as shown in FIG. 19 are increased to the side of a bottom 2j of circumferential groove 2d as shown by hatched triangles in FIGS. 20A and 20B. As a result, a friction resistance is increased between the bottom of circumferential caulked part 60a and bottom 2j of circumferential groove 2d, obtaining a sufficient tightening or coupling force at caulked part 60a.

On the other hand, when the atmospheric temperature is greater than an ordinary temperature, i.e. about 30° C. or 40° C., inner-periphery-side cylinder 60 produces expansion deformation in the diameter increasing direction, reducing a tightening force of cylinder 60 to the outer peripheral surface of input shaft 2. However, an axial stress generated at circumferential caulked part 60a is increased as shown in FIG. 19, so that at a point C and a point D in FIG. 19, a friction resistance between both sides of the protruding inner surface of caulked part 60a and opposed faces 2h, 2h of circumferential groove 2d is increased as shown in hatched triangles in FIGS. 20C and 20D, obtaining a strong coupling force at caulked part 60a.

Specifically, the expansion amount of circumferential caulked part 60a and axial caulked part 60b is greater than the diameter increasing amount of circumferential groove 2d and concave 2f, providing axial interference. With this, axial caulked part 60b is tightly engaged in concave 2f, obtaining strong coupling. This allows sure prevention of axial and circumferential free rotation of circumferential caulked part 60a, resulting in restraint of a reduction in detection accuracy obtained by torque sensor TS.

Further, annular spacer 10 is interposed between yoke members 80, 90 to determine an axial clearance between torque detection coil 8 and temperature compensation coil 9, allowing assembling of coils 8, 9 with the positional relationship therebetween maintained, resulting in easy fulfillment of clearance control between yoke members 80, 90 (coils 8, 9).

Still further, as described above, assembling of torque sensor TS is carried out, preferably, such that after connecting input and output shafts 2, 3 through torsion bar 4, the sensor members such as torque detection coil 8 and the like are inserted into input and output shafts 2, 3 for assembling. Specifically, when connecting input and output shafts 2, 3, pin mounting hole 2g is to be formed to fix the upper end of torsion bar 4 to input shaft 2 by pin 2b, which produces a contaminant such as chip and cutting oil. Thus, when connecting input and output shafts 2, 3 after inserting the sensor members such as torque detection coil 8 and the like, a contaminant and cutting oil can be adhered to the sensor member.

Then, in the embodiment, as described above, before assembling of all the sensor members such as torque detection coil 8 and the like from the side of input shaft 2, pin mounting hole 2g is formed to fix the upper end of torsion bar 4 to input shaft 2 by pin 2b, and pin 2b is fitted therein, allowing prevention of a contaminant and cutting oil from adhering to the sensor members.

Furthermore, recesses 80e, 90e and axial protrusions 22, 23 are arranged between yoke members 80, 90 and spacer 10 to prevent relative rotation therebetween, allowing assembling with coil harnesses 8a, 9a of coils 8, 9 aligned with each other with respect to the direction of protrusion. And positioning protrusions 24a, 24b and axial engagement groove 122 are arranged between spacer 10 and upper housing 110 to prevent relative rotation therebetween, allowing assembling with coil harnesses 8a, 9a of coils 8, 9 aligned with wiring box 110e of upper housing 110. This results in an enhancement in assembling workability.

Further, fixing of yoke members 80, 90 to housing 1 is carried out at stationary flange parts 80d, 90d protruding outwardly from the opening edges arranged on the side of outer-periphery surrounding parts 80c, 90c of the main bodies of gate-shaped section for surrounding members 6, 7 and coils 8, 9 except their faces opposite to surrounded member 5. Thus, yoke members 80, 90 can be fixed to housing 1 without varying an internal stress of the main bodies which form the magnetic paths in yoke members 80, 90, resulting in achievement of a desired torque detection accuracy.

Still further, fixing of yoke members 80, 90 to housing 1 is carried out with yoke members 80, 90 axially biased at stationary flange parts 80d, 90d having spacer 10 interposed therebetween through disc spring 12 and base member 11. Thus, only arrangement of disc spring 12 allows easy assembling of yoke members 80, 90 to housing 1 without varying an internal stress of the main bodies which form the magnetic paths in yoke members 80, 90. Moreover, a biasing force of disc spring 12 allows prevention of positional displacement of yoke members 80, 90 (torque detection coil 8, temperature compensation coil 9).

Furthermore, fixing of yoke members 80, 90 to housing 1 is carried out with yoke members 80, 90 axially biased at stationary flange parts 80d, 90d having spacer 10 interposed therebetween through base member 11. With this, only change of base member 1 allows easy change in axial mounting position of yoke members 80, 90 (torque detection coil 8, temperature compensation coil 9) with respect to housing 1, surrounding members 6, 7, and surrounded member 5 without having design modification of housing 1 itself.

According to the present invention, when assembling the cylindrical member to the shaft member, the cylindrical member is engaged on the outer peripheral surface of the shaft member by a predetermined length in loose fit and not in press fit. Then, the cylindrical member is caulked from the outside at a forming position of the axial groove or the circumferential groove.

The cylindrical member is formed out of a material (aluminum-alloy material, for example) which is greater in linear expansion coefficient than a material (iron material, for example) of the shaft member. Thus, when caulking the cylindrical member at an ordinary temperature, the deformed inner surface of the caulked portion is in press contact with the opposed faces of the groove of the shaft member, obtaining strong coupling by great friction resistance or interference.

When the atmospheric temperature is low, the cylindrical member is greater in contraction-deformation amount than the shaft member, thus obtaining the whole inner peripheral surface of the cylindrical member in press contact with the outer periphery of the shaft member. Moreover, the friction resistance is slightly reduced between the two inner surfaces of the caulked portion and the opposed faces of the groove facing thereto, whereas the friction resistance is increased between the bottom of the caulked portion and that of the groove facing thereto in accordance with radial contraction deformation of the members, obtaining a sufficient tightening or coupling force at the caulked portion.

On the other hand, when the atmospheric temperature is high, a tightening force to the outer peripheral surface of the shaft member is reduced by deformation of the cylindrical member in the diameter increasing direction, whereas the friction resistance is increased between the two inner surfaces of the caulked portion and the opposed faces of the groove, obtaining a strong coupling force.

Further, according to the present invention, caulking is carried out at a position of the intersection of the axial groove and the circumferential groove, so that the caulked portion is engaged in the grooves with the whole inner surface of the caulked portion conforming to the opposed faces and bottom of the grooves. Therefore, when the atmospheric temperature is particularly high, the caulked portion also produces expansion deformation, so that the whole inner surface of the caulked portion are in press contact with the opposed faces of the grooves to generate a great friction resistance, obtaining strong coupling of the cylindrical member to the shaft member. This allows sure prevention of axial and circumferential free rotation of the cylindrical member.

Still further, according to the present invention, plastic deformation of the surrounding member is prevented from occurring during assembling of the surrounding member to the input shaft or the output shaft. Moreover, the surrounding member can strongly be coupled to the input shaft or the output shaft when having a change in atmospheric temperature of the torque sensor, preventing positional displacement, resulting in restraint of a reduction in detection accuracy obtained by the torque sensor.

Furthermore, according to the present invention, the cylindrical member is simply engaged on the shaft member, and not press fitted thereto, then it is subjected to caulking, achieving simplified assembling, resulting in restraint of increased manufacturing cost. Moreover, the inner surface of the caulked portion is tightly engaged on the opposed faces of the axial groove or the circumferential groove of rectangular section. Thus, even if the cylindrical member produces deformation in the diameter decreasing or increasing direction in accordance with a change in atmospheric temperature, a great friction resistance is ensured at the caulked portion, obtaining strong coupling.

Having described the present invention with regard to the illustrative embodiment, it is noted that the present invention is not limited thereto, and various changes and modifications can be made without departing from the scope of the present invention. By way of example, in the embodiment, the surrounding member is arranged on the side of input shaft 2, whereas the surrounded member is arranged on the side of output shaft 3. Optionally, the surrounding member may be arranged on the side of output shaft 3, whereas the surrounded member may be arranged on the side of input shaft 2. Moreover, in the embodiment, operation of forming pin mounting hole 2g and press fitting pin 2b therein is carried out after assembling housing 1. Optionally, this operation may be carried out before assembling housing 1.

The entire contents of Japanese Patent Application 2002-299783 filed Oct. 15, 2002 are incorporated hereby by reference.

What is claimed is:

1. A structure, comprising:
a shaft member, the shaft member being formed out of a first material, the shaft member having an outer periphery formed with at least one of an axial groove and a circumferential groove, the at least one groove having a cross section having opposed faces substantially parallel to each other;
a cylindrical member fitted to the outer periphery of the shaft member, the cylindrical member being formed out of a second material, the second material being greater in linear expansion coefficient than the first material; and
a caulked portion provided to the cylindrical member at a position corresponding to the at least one groove of the shaft member, the caulked portion having a deformed inner surface in press contact with the opposed faces of the at least one groove.

2. The structure as claimed in claim 1, wherein the axial groove and the circumferential groove are different in depth from each other, the caulked portion being placed at an intersection of the axial groove and the circumferential groove, wherein the deformed inner surface is in press contact with the opposed faces of the axial groove and the circumferential groove at the intersection.

3. The structure as claimed in claim 2, wherein the axial groove is greater in depth than the circumferential groove.

4. The structure as claimed in claim 2, wherein the caulked portion is greater in circumferential width than the intersection of the axial groove and the circumferential groove.

5. The structure as claimed in claim 4, wherein the caulked portion comprises a first caulked part corresponding to the circumferential groove and a second caulked part corresponding to the axial groove, the second caulked part being arranged substantially in a middle of the first caulked part.

6. The structure as claimed in claim 1, wherein the axial groove comprises a plurality of groove portions in a circumferential direction.

7. The structure as claimed in claim 6, wherein the plurality of groove portions of the axial groove are three in number.

8. The structure as claimed in claim 1, wherein the cross section of the axial groove and the circumferential groove is rectangular.

9. The structure as claimed in claim 1, wherein the cylindrical member is loosely fitted to the shaft member except the caulked portion.

10. The structure as claimed in claim 1, wherein the axial groove has an opening edge formed at an acute angle.

11. The structure as claimed in claim 1, wherein the axial member comprises one of an input shaft and an output shaft arranged relatively rotatably with respect to the input shaft, the input shaft and the output shaft being used for a torque sensor of an electric power steering apparatus.

12. A method of coupling a shaft member and a cylindrical member, comprising:
forming the shaft member out of a first material;
forming in an outer periphery of the shaft member at least one of an axial groove and a circumferential groove, the at least one groove having a cross section having opposed faces substantially parallel to each other;
forming the cylindrical member out of a second material, the second material being greater in linear expansion coefficient than the first material;
fitting the cylindrical member to the outer periphery of the shaft member; and
caulking the cylindrical member at a position corresponding to the at least one groove of the shaft member, the caulking step providing a caulked portion having a deformed inner surface in press contact with the opposed faces of the at least one groove.

13. The method as claimed in claim 12, wherein the axial groove and the circumferential groove are different in depth from each other, the caulked portion being placed at an intersection of the axial groove and the circumferential groove, wherein the deformed inner surface is in press contact with the opposed faces of the axial groove and the circumferential groove at the intersection.

14. The method as claimed in claim 13, wherein the axial groove is greater in depth than the circumferential groove.

15. The method as claimed in claim 13, wherein the caulked portion is greater in circumferential width than the intersection of the axial groove and the circumferential groove.

16. The method as claimed in claim 15, wherein the caulked portion comprises a first caulked part corresponding to the circumferential groove and a second caulked part corresponding to the axial groove, the second caulked part being arranged substantially in a middle of the first caulked part.

17. The method as claimed in claim 12, wherein the caulking step is carried out with a caulker having a head of a flat section, wherein the caulking step is carried out by making the head of the caulker in press contact with the cylindrical member.

18. The method as claimed in claim 17, wherein the head of the caulker is of a shape substantially corresponding to the circumferential groove.

19. The method as claimed in claim 12, wherein the caulking step is carried out at a temperature of about 20° C.

20. The method as claimed in claim 12, further comprising:
positioning, prior to the caulking step, the cylindrical member with respect to the axial member in a loosely fitted state.
